(19) United States
(12) Patent Application Publication
(10) Pub. No.: US 2015/0262221 A1
(43) Pub. Date: Sep. 17, 2015

(54) LINKING OFFLINE ACTIONS WITH ONLINE ACTIVITIES

(71) Applicants: Jun NAKANO, Tokyo (JP); Kunihiko Sakamoto, Tokyo (JP)

(72) Inventors: Jun NAKANO, Tokyo (JP); Kunihiko Sakamoto, Tokyo (JP)

(73) Assignee: Google Inc.

(21) Appl. No.: 13/473,521

(22) Filed: May 16, 2012

(51) Int. Cl. G06Q 30/02

(52) U.S. Cl. CPC G06Q 30/0246; G06Q 30/0275

(57) ABSTRACT

Systems and methods allow association between online activities and offline actions. A computer-implemented method includes: generating, using at least one processing circuit, at least one unique ID associated with at least one online activity related to a user identifier; transmitting a machine-readable image to a first user device for presentation at an offline location in conjunction with at least one offline action related to the user identifier, wherein the machine-readable image contains information related to the unique ID; receiving, using at least one processing circuit, data obtained from accessing the machine-readable image at the offline location; and associating, based on the received data, the at least one online activity with the at least one offline action using the at least one unique ID.

### BACKGROUND

The Internet provides access to a wide variety of resources, such as video files, audio files, pictures, business and personnel contact information, product information, maps, and news articles. Activities related to accessing these resources present opportunities for electronic commerce such as advertising to be provided with the resources.

### SUMMARY

Systems and methods allow association between online activities and offline actions. In an aspect, a computer-implemented method includes: generating, using at least one processing circuit, at least one unique ID associated with at least one online activity related to a user identifier; transmitting a machine-readable image to a first user device for presentation at an offline location in conjunction with at least one offline action related to the user identifier, wherein the machine-readable image contains information related to the unique ID; receiving, using at least one processing circuit, data obtained from accessing the machine-readable image at the offline location; and associating, based on the received data, the at least one online activity with the at least one offline action using the at least one unique ID.

In some implementations, the at least one online activity includes at least one of: a viewing of an advertisement; an interaction with the advertisement; a visit to an advertiser's website related to the advertisement; or a visit to a review website related to the advertisement. The at least one offline action includes at least one of: a visit to a physical store at the offline location, a purchase of an advertised item product or service at the offline location; or using the advertised item.

In some implementations, the method further includes determining a performance metric of the advertisement as a function of the association between the at least one offline action and the at least one online activity; determining a pricing value of the advertisement based on the performance metric; and determining a target bid for an advertising slot for the advertisement based on the pricing value of the advertisement. The machine-readable image may include at least one of a QR code or a barcode specific to the at least one online activity. The method may further include auctioning the advertising slot based on a bid received from an advertiser and the pricing value of the advertisement. In some implementations, the method includes comprising charging an account associated with the advertiser for the at least one offline action.

In some implementations, the method includes determining a ranking of the advertisement based on an effective cost of impressions that is a function of the at least one offline action.

In some implementations, the machine-readable image is transmitted to and automatically displayed on the first user device. The method may further include transferring the machine-readable image to a second user device or medium for access at the offline location. The machine-readable image may include at least one of a QR code or a barcode, and the transferring may include scanning the QR code or barcode on the first user device using the second user device or printing the QR code on a piece of paper. In some implementations, the method may include scanning the QR code or the barcode from the second user device or from the piece of paper at the offline location.

In some implementations, the unique ID comprises at least one cookie stored on a user device. The unique ID may include a link to a page configured to generate a QR code specific to the at least one online activity. The method may include generating the QR code only if the at least one online activity includes a click on an advertisement.

In another aspect, a system is configured to link online activities with offline actions. The system may include: at least one processing circuit connected to a network, the at least one processing circuit configured to: generate at least one unique ID associated with at least one online activity related to a user identifier; transmit a machine-readable image to a user device for presentation at an offline location in conjunction with at least one offline action related to the user identifier, wherein the machine-readable image contains information related to the unique ID; receive data obtained from accessing the machine-readable image at the offline location; and associate, based on the received data, the at least one online activity with the at least one offline action using the at least one unique ID.

In some implementations, the at least one online activity includes at least one of: a viewing of an advertisement; an interaction with the advertisement; a visit to an advertiser's website related to the advertisement; or a visit to a review website related to the advertisement, and the at least one offline action comprises at least one of: a visit to a physical store at the offline location, a purchase of an advertised item product or service at the offline location; or using the advertised item at the offline location.

In some implementations, the at least one unique ID comprises at least one of a QR code or a barcode specific to the at least one online action. In some implementations, the unique ID includes at least one cookie, and the at least one processing circuit is further configured to: generating a quick response (QR) code when accessing the at least one cookie.

In some implementations, the unique ID includes at least one quick response (QR) code indicating at least one URL link, and wherein the at least one processing circuit is further configured to: redirect a request for a web page to an advertiser's landing page having the at least one link.

In another aspect, a non-transitory computer readable medium having instructions stored thereon is provided. The instructions may include: generating at least one unique ID associated with at least one online activity related to a user identifier; transmitting a machine-readable image to a user device for presentation at an offline location in conjunction with at least one offline action related to the user identifier, wherein the machine-readable image contains information related to the unique ID; receiving data obtained from accessing the machine-readable image at the offline location; and associating, based on the received data, the at least one online activity with the at least one offline action using the at least one unique ID.

In some implementations, the unique ID includes at least one cookie, and the instructions include: generating a quick response (QR) code when accessing the at least one cookie. In some implementations, the unique ID includes at least one link, and the instructions further include: redirecting a request for a web page to an advertiser's landing page having the at least one link.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

The foregoing and other aspects, implementations, and features of the present teachings can be more fully understood from the following description in conjunction with the accompanying drawings.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

The foregoing and other aspects, implementations, and features of the present teachings can be more fully understood from the following description in conjunction with the accompanying drawings.

### BRIEF DESCRIPTION OF THE DRAWINGS

The skilled artisan will understand that the figures, described herein, are for illustration purposes only. It is to be understood that in some instances various aspects of the described implementations may be shown exaggerated or enlarged to facilitate an understanding of the described implementations. In the drawings, like reference characters generally refer to like features, functionally similar and/or structurally similar elements throughout the various figures. The drawings are not necessarily to scale, emphasis instead being placed upon illustrating the principles of the teachings. The drawings are not intended to limit the scope of the present teachings in any way.

FIG. 1 is a diagram illustrating examples of various entities that can interact with an advertising system.

FIG. 2 is a diagram illustrating an example advertising environment.

FIG. 3 is a block diagram of an example webpage that may be generated by a page assembly operation of an advertisement consumer, for rendering on a viewer's screen.

FIG. 4A is a diagram illustrating an example flow of operations for linking online activities with offline actions according to some of the described implementations.

FIG. 4B is a diagram illustrating another example of flow of operations for linking online activities with offline actions according to some other described implementations.

FIG. 5A is a block diagram illustrating a broken link between online and offline actions in an advertising system.

FIG. 5B is a block diagram illustrating a link between online and offline actions established through a unique ID according to some of the described implementations.

FIG. 5C is a diagram illustrating embedding HTML code to generate a portable unique ID according to some implementations.

FIG. 6A is diagram illustrating an example set of data indicating the number of conversions for different geographic locations.

FIG. 6B is a diagram illustrating an example set of data indicating the number of conversions as a function of the time of the day.

FIG. 7 is a block diagram illustrating a system that can be used to perform at least some of the various operations according to some implementations.

FIG. 8A is a block diagram illustrating the linking between an online advertisement click and an offline purchase using a mobile application according to some implementations.

FIG. 8B is a block diagram illustrating the linking between an online advertisement click and an offline purchase without a mobile application according to some other implementations.

FIG. 9 is a block diagram of an advertiser's platform for controlling the advertisement performance metric to include offline actions.

FIG. 10 is a flowchart illustrating some of the various operations according to some implementations.

### DETAILED DESCRIPTION

Below are more detailed descriptions of various concepts related to, and implementations of, inventive methods and systems for linking offline and online activities. It should be appreciated that various concepts introduced above and discussed in greater detail below may be implemented in any of numerous ways, as the disclosed concepts are not limited to any particular manner of implementation. Examples of specific implementations and applications are provided primarily for illustrative purposes.

A webpage such as a search result page or a content page as requested by a user can include slots in which alternative content items (e.g., advertisements) can be presented. These advertisement slots can be defined in the webpage or defined for presentation with a webpage, for example, as part of the webpage, or in a pop-up window. As used herein, a “user” or a “user identifier” may refer to an identifier of an individual user, a user device, a user browser, etc., and does not necessarily refer to the actual individual user. Users may opt out of data collection, and users may opt in to provide additional demographic data for improved online experience. The identifiers associated with user data may be anonymized and not connected to user names or actual identities, or other sensitive information.

Slots on web pages can be allocated to content providers (e.g., advertisers) through an auction. For example, advertisers can provide bids specifying amounts that the advertisers are respectively willing to pay for presentation of their advertisements. In turn, an auction can be performed and the advertisement slots can be allocated to advertisers according to their bids. When one advertisement slot is being allocated in the auction, the advertisement slot can be allocated to the advertiser that provided the highest bid or a highest auction score (e.g., a score that may be computed as a function of a bid and/or an advertisement quality measure, where the advertisement quality measure can be how well the content of the advertisement matches searches for certain keywords). When multiple advertisement slots are allocated in a single auction, the advertisement slots can be allocated to a set of bidders based on the highest bids, the highest auction scores, and/or other factors.

Content management accounts can enable content providers (e.g., advertisers) to specify keywords and corresponding bids that are used to control allocation of their content items (e.g., advertisements). The advertiser can obtain the performance of advertisements that are provided using the keywords and corresponding bids. For example, an advertiser can access the advertisement management account and view performance measures corresponding to the advertiser's advertisements that were distributed using each keyword. In turn, the advertiser can adjust settings that control the allocation of advertisements and compare the performance measures for the advertisements that are allocated using the new settings.

The advertising can be part of Internet marketing (also known as online marketing, web marketing, or e-marketing). The effectiveness of online marketing can be measured by cost per impression (CPI), or cost per thousand impressions (CPM), where an impression may be counted for example whenever an advertisement server counts a loading of an advertisement onto a user's screen. Some of the impressions lead to user identifiers' interacting with the ad (such as a click), and a click-through rate (CTR) may be defined as the number of clicks on the advertisement divided by the number of impressions.

Advertisement pricing sometimes can be more accurately determined by cost per action (CPA). The actions may include, for example, user identifiers' interacting with the advertisement such as clicking on the advertisement or a link therein, user identifiers' purchase of a product, user identifiers' referring the advertisement to other user identifiers, etc. Correspondingly, the advertisement pricing may be measured as cost per click-through (CPC; counted when an advertisement is clicked), cost per sale (CPS), and cost per lead (CPL). Sometimes an effective CPM (eCPM) may be used to measure the effectiveness of an ad, where actual actions such as clicks may be factored into the calculation.

An advertisement campaign generally refers to an advertising activity, such as delivering specifically relevant ads to user identifiers in certain geographical locations, delivering specifically relevant ads to different product lines, or delivering specifically relevant ads to certain user identifier groups. Campaign information may include, for example, one or more budgets for one or more time periods (e.g., a daily budget), geographical information, syndication preference information, start and end dates of the campaign, etc.

The ads may be associated with searches, where users may be attracted to the ads through search result pages, and the searches can lead to the users' clicks on the ads. Each campaign may be associated with one or more advertisement groups. An advertisement group may include one or more ads that can be associated with different sets of keywords. Advertisement group information may include, for example, keywords that may be used by a relevancy determination operation to decide whether to show the advertisement on a search page resulting from the keywords, and cost information such as a maximum bid for the advertiser. The different ads within one advertisement group may have different unique identifiers, and advertisers may be allowed to see the different performances of the different ads from the advertisers' web access.

Some of the user identifiers visiting the webpage may take a desired action beyond simple browsing (impression) of the webpage. The desired actions may include, for example, purchasing a product or service, visiting a physical store, test using a product or service such as test driving a vehicle, joining a membership, opening an account, subscribing a newsletter, downloading an application, etc. The percentage of such visitors taking the desired actions may be referred to as the conversion rate.

An online content item, such as an advertisement and its associated outcome (e.g., user identifiers' purchase of advertisers' items or services for sale) can be associated with both online and offline actions. In general, “online” indicates a state of connectivity such as to the Internet, while “offline” indicates a disconnected state. If a user identifier clicks through an ad, then buys a product at the advertiser's website using an online account, these would be considered online actions. It may be relatively straightforward to link this type of online purchases with impressions and with the effectiveness of the ads.

Some activities may occur during a web browsing session during which the advertisement is viewed (e.g., a click on an ad), while other activities may occur outside of the web browsing session. Examples of offline actions associated with the advertising may include users' walking into a physical store, for example to redeem coupons, purchase or try out items as advertised in the online advertisement. The store and/or the items being purchased or tried out may be associated with a manufacturer or a merchant who provided or may be associated with the advertisement. In general, offline actions can refer to activities relating to products or services outside of the internet session that generated an advertisement that may have led the user identifiers to the offline actions.

Content providers (e.g., advertisers) can be provided with user identifier interaction reports that measure various user identifier interactions with the content that may be distributed to the user identifiers for the content providers. In some implementations, the reports that may be provided to a particular content provider specify performance measures representing user identifier interactions with content that occur prior to a conversion. In some cases, the reports may be provided on an anonymized basis. It is noted that users may opt out of data collection, or alternatively a user may be asked to opt-in before data collection begins. The collected data can be anonymized, or individual user identifiers can be anonymized such that actual user information such as names, credit card numbers, and phone numbers cannot be derived from the user IDs. Thus, a user's privacy can be maintained, should the user so desire.

User identifier interactions can include any presentation of content to a user and any subsequent affirmative actions (including online actions and offline actions) or non-actions that a user identifier takes in response to presentation of content to the user (e.g., selections of the content following presentation of the content, or no selections of the content following the presentation of the content). Thus, a user interaction may not necessarily require a selection of the content (or any other affirmative action) by the user.

Advertisement performance metrics and pricing typically take into account only online activities, as offline actions have been difficult to log and analyze. Implementations described herein enable linking between offline actions with online activities, thereby allowing offline actions be factored into the ad performance metrics and pricing.

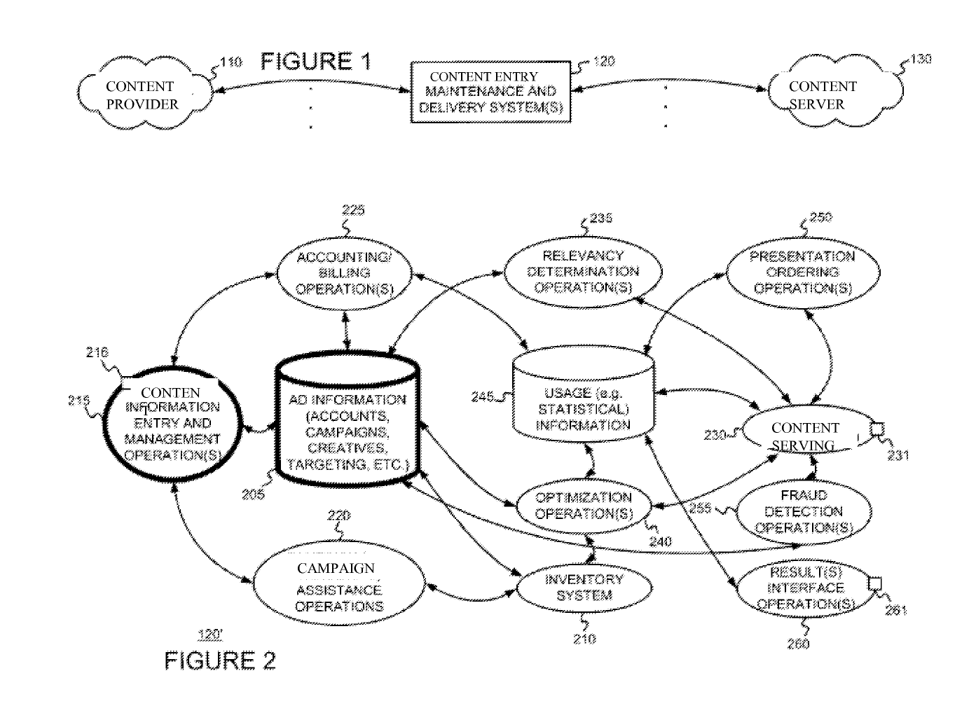

FIG. 1 is a diagram of an example of a content delivery (e.g., advertising) environment where systems and methods disclosed herein may be implemented. The environment may include a content entry, maintenance and delivery system 120. Content providers (e.g., advertisers) 110 may directly, or indirectly, enter, maintain, and log content information in the system 120. The content items (e.g., ads) may be in the form of graphical ads such as so-called banner ads, text-only ads, text-based ads, audio ads, video ads, ads combining various media types, or other content items. Content server 130 may submit requests for ads to the system 120, and provide historical or usage information to the system 120. Although not shown, other entities may provide historical or usage information (e.g., whether a conversion or click-through related to the advertisement occurred) to the system 120.

Content server 130 may be a general content provider that receives requests for content (e.g., articles, discussion threads, music, video, graphics, search results, webpage listings, etc.), and retrieves the requested content in response to, or otherwise services, the request. The content server may submit a request for content (e.g., ads) to the system 120. Such a request may include a number of content items desired. The request may include content request information. This information may include the content itself (e.g., a page), a category corresponding to the content or the content request (e.g., arts, business, computers, arts-movies, arts-music, etc.) part of all of the content request, content age, content type (e.g., text, graphics, video, audio, mixed media, etc.), geo-location information, etc.

The content server may combine the requested content with one or more of the advertisements provided by the system 120. This combined information including the content and advertisement(s) may then be forwarded to the end user identifier that requested the content. The content server may transmit information about the ads and how the ads may be to be rendered (e.g., position, click-through or not, impression time, impression date, size, conversion or not, etc.) back to the system 120. Alternatively, or in addition, such information may be provided back to the system 120 by some other means.

Another example of a content server 130 is a search engine. A search engine may receive queries from various user identifiers for search results. In response, the search engine may retrieve relevant search results (e.g., from an index of web pages). Such search results may include, for example, lists of webpage titles, snippets of text extracted from those web pages, and hypertext links to those web pages, and may be grouped into a predetermined number of search results as a search result page.

The search engine may submit a request for ads to the system 120. The request may include a number of ads desired. This number may depend on the search results, the amount of screen or page space occupied by the search results, the size and shape of the ads, etc. For example, the number of desired ads can be from one to ten, such as from three to five. The request for ads may include the query (as entered or parsed), information based on the query (such as geo-location information, whether the query came from an affiliate and an identifier of such an affiliate), and/or information associated with, or based on, the search results. Such information may include, for example, identifiers related to the search results (e.g., document identifiers), scores related to the search results (e.g., information retrieval scores such as dot products of feature vectors corresponding to a query and a document, page rank scores, and/or combinations of information retrieval scores and page rank scores), snippets of text extracted from identified documents (e.g., web pages), full text of identified documents, feature vectors of identified documents, etc.

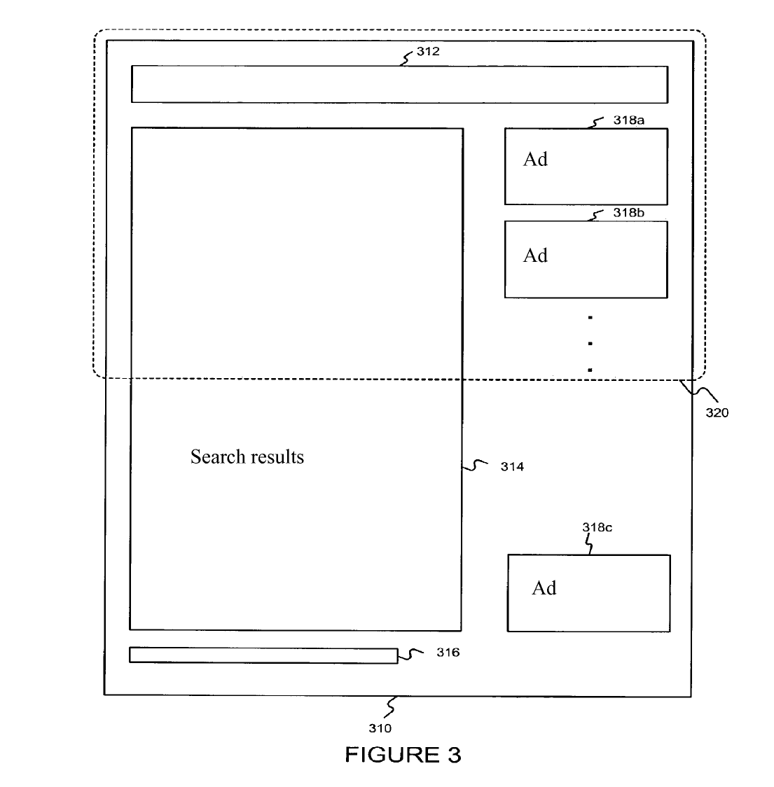

The search engine may combine the search results with one or more of the advertisements provided by the system 120. This combined information including the search results and advertisement(s) can then be forwarded to the user identifier that requested the content, for presentation to the user. For example, FIG. 3 shows an abstract illustration of a display page 310 that may be provided by the search engine. The outline 320 depicted with dashed lines corresponds to a portion of the display page 310 that may be viewed on a typical personal computer (PC) display screen. The example display page 310 may include header information 312 (e.g., the name of search engine host), trailer information 316 (e.g., copyright, navigational hypertext links, etc.), a plurality of search results 314 and a plurality of ads 318a, 318b, and 318c. The search results 314 may be maintained or displayed as distinct from the ads 318, so as not to confuse the user identifier between paid advertisements and other search results. For example, ads 318 may be shaded, labeled as “Ads” or “Sponsored Links,” and placed on a side or top portion of the display page 310. Although FIG. 3 shows only three ads 318, various implementations may have more or less ads. For example, ten search results combined with ten ads can be shown.

The search engine may transmit information about the advertisement and/or how the advertisement was rendered historically, or how the advertisement may be rendered (e.g., position, click-through or not, impression time, impression date, size, conversion or not, etc.) back to the system 120. Alternatively, or in addition, such information may be provided back to the system 120 by some other means.

FIG. 2 illustrates an example advertisement system 120′ with which, or in which, various implementations may be used. The example advertisement system 120′ may include an inventory system 210 and may store advertisement information 205 and usage or historical (e.g., statistical) information 245. The example advertisement system 120′ may support advertisement information entry and management operation(s) 215, campaign assistance operation(s) 220, accounting and billing operation(s) 225, advertisement serving operation(s) 230, relevancy determination operation(s) 235, optimization operations 240, presentation ordering operations 250, fraud detection operation(s) 255, and result(s) interface operation(s) 260. Advertisers 110 may interface with the system 120′ via the advertisement information entry and management operation(s) 215 as indicated by interface 216. Content server 130 may interface with the system 120′ via the advertisement serving operation(s) 230 as indicated by interface 231. Content server 130 or other entities (not shown) may interface with the system 120′ via results interface operation(s) 260 as indicated by interface 261.

The advertisement information 205 can be entered and managed via the advertisement information entry and management operation(s) 215. Campaign assistance operation(s) 220 can be employed to help advertisers 110 generate effective advertisement campaigns. The campaign assistance operation(s) 220 can use information provided by the inventory system 210, which, in the context of advertising for use with a search engine, may log or store all possible advertisement impressions, advertisement impressions already reserved, and advertisement impressions available for given keywords. The advertisement serving operation(s) 230 may service requests for ads from content server 130.

The advertisement serving operation(s) 230 may use relevancy determination operation(s) 235 to determine candidate ads for a given request. The advertisement serving operation(s) 230 may then use optimization operation(s) 240 to select a final set of one or more of the candidate ads. That is, the relevancy determination operation(s) may be used to determine ads that may be served. The optimization operation(s) may then determine whether or not each of the candidate ads is, in fact, served. The advertisement serving operation(s) 230 may use presentation ordering operation(s) 250 to order the presentation of the ads to be returned. The fraud detection operation(s) 255 can be used to reduce fraudulent use of the advertising system (e.g., by advertisers), such as through the use of stolen credits cards. The result(s) interface operation(s) 260 may be used to accept result information (from the content server 130 or some other entity) about an advertisement actually served, such as whether or not click-through occurred, whether or not conversion occurred (e.g., whether the sale of an advertised item or service was initiated or consummated within a predetermined time from the rendering of the ad), etc. Such result(s) information may be accepted at interface 261 and may include information to identify the advertisement and time the advertisement was served, as well as the associated result.

However, existing online advertising solutions do not have the capability of logging offline conversions, where a user identifier who viewed and/or clicked on an online advertisement may choose to visit a physical store, purchase the advertised item (product, service, etc.) from a physical store, or use the advertised item offline.

In some of the described implementations, a unique ID (e.g., cookie) may be generated by a search engine provider, and stored on the user device in association with the browser of the user identifier. When the user identifier visits a certain web page, and/or clicks on the advertisement, the browser may send the cookie back to the search engine provider. The cookie may be specific to the user identifier, and/or may be specific to the clicking action. Users may opt out the cookie generation and delivery, and can delete cookies.

Content of the cookie can be shown in the HTML body. The cookie may be converted into a quick response (QR) code, a barcode, or any other coded content item. The QR code can associate the user identifier with an offline action when scanned at the offline location. Personal identification information may be hashed to protect users' privacy. The QR code may be shown on the landing page of the clicked advertisement. In an example, a simple HTML snippet (e.g., a one-line code) may be added to the landing page to generate the QR code. Because the cookie can be unique to the click, different user identifiers (or even the same user identifier with different browsers) may see different QR codes.

The QR codes from the web pages may then be transferred to another medium (such as printed to a piece of paper), sent to a mobile phone via emails or wireless connections, etc. Advertisers may provide incentives to those user identifiers who bring the QR codes to a store and carry out conversions defined by the advertisers.

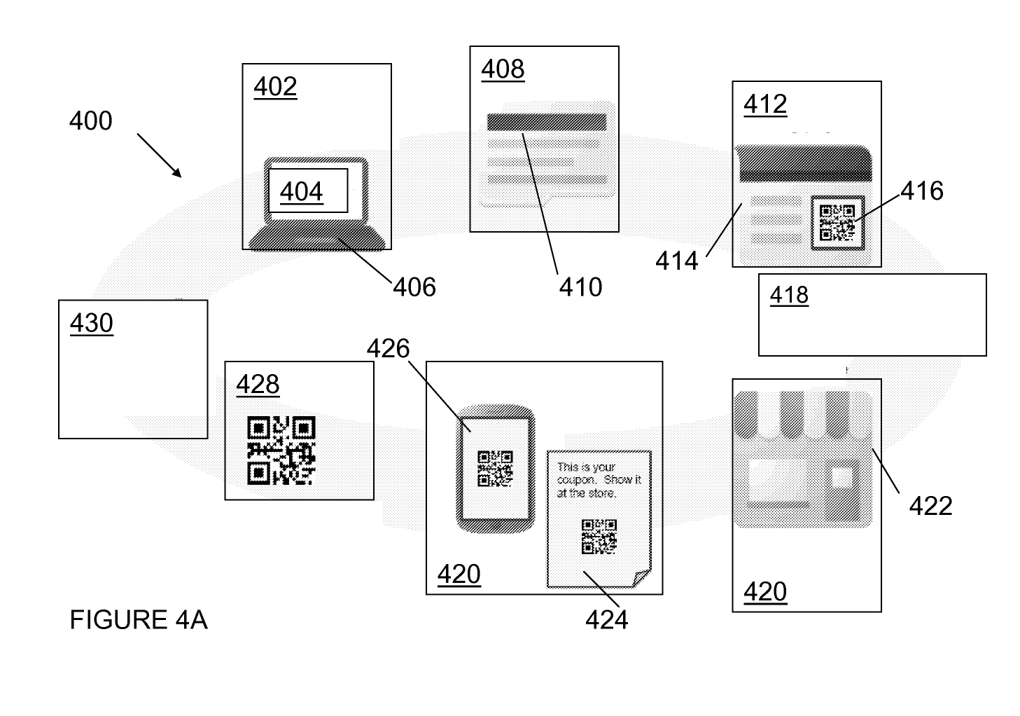

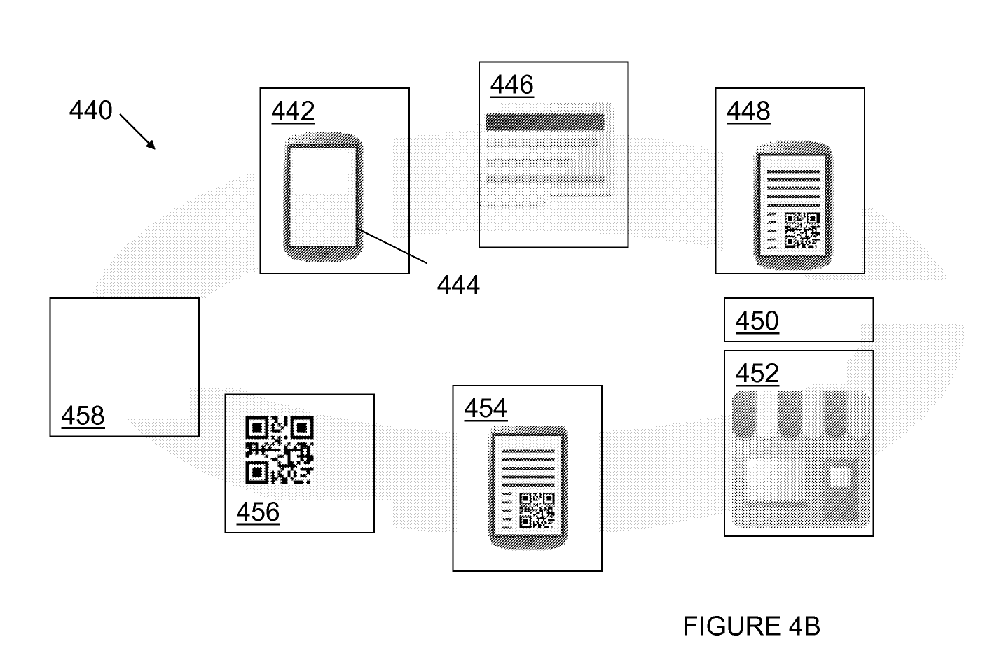

FIG. 4A illustrates an example flow 400 of offline conversion logging. In this example, at block 402, a user identifier conducts a search on a search engine 404, for example using a user device such as a personal computer 406. At block 408, the user identifier may click on an advertisement 410. The advertisement 410 can be a textual advertisement or an imagery advertisement. At block 412, the landing page 414 may show a unique ID such as a QR code 416 that enables the search engine provider to uniquely identify the preceding click. At block 418, the user identifier can print the landing page 414 including the QR code 416, or print the QR code 416 itself The user identifier can alternatively send the information contained in the QR code to a portable device such as a mobile phone, for example by scanning the QR code 416 using the mobile phone, transferring (wirelessly or using a cable) an information item (such as the QR itself or a link to a QR) to the cellular phone.

At block 420, the user may visit a physical store 422 at an offline location. The user can show the printed QR code on a piece of paper 424. Alternatively, the user can show the QR code on the mobile phone 426. The QR code can be saved on the mobile phone 426, or displayed from a bookmarked QR code page or link. At block 428, the merchant can scan the QR code in conjunction with a conversation activity. At block 430, the search engine provider can receive data indicative of the conversion from the merchant, and the conversion can be associated with the ad click.

At the blocks 412, 418, to minimize the changes to the HTML code of the landing page 414, and to minimize the exposure of user information such as the email address, a send-to-phone feature may be implemented as follows. The cookie value may be converted into a QR code that represents a unique, static URL pointing to a search engine server (e.g., http://example-server/?value=cookie value). The server may be configured such that it shows the same or substantially similar QR code as the one on the landing page when the user identifier visits the above URL. In this way, the user identifier can obtain (e.g., scan) the QR code on the landing page using a mobile phone, visit the URL (encoded in the QR code) using the mobile phone browser, and bookmark it. By revisiting the bookmarked page at the store, the user identifier can show the QR code to the merchant.

In an alternative implementation 440 illustrated in FIG. 4B, at block 442, a user identifier can conduct a search on a smart phone or other mobile device 444. At block 446, the user identifier can click the ad on the smart phone. At block 448, the smart phone can display the landing page with the QR. At block 450, the page with the QR code may be bookmarked. At block 452, the user identifier can bring the smart phone 444 to an offline location such as a physical store. At block 454, the bookmarked page can be opened and the QR code can be shown to a merchant. At block 456, the merchant can receive the unique ID from the user identifier such as by scanning the QR code from the smart phone, in conjunction with a conversion action. At block 458, an association can be made between the conversion and the online ad click at the server.

The methods employing QR codes do not assume priori connections (such as using credit card numbers, etc.). In existing advertising systems, advertisers already embed a one-line code in their websites. Thus, it may be straightforward to have the advertiser modify the HTML to include a piece of code to generate the QR code.

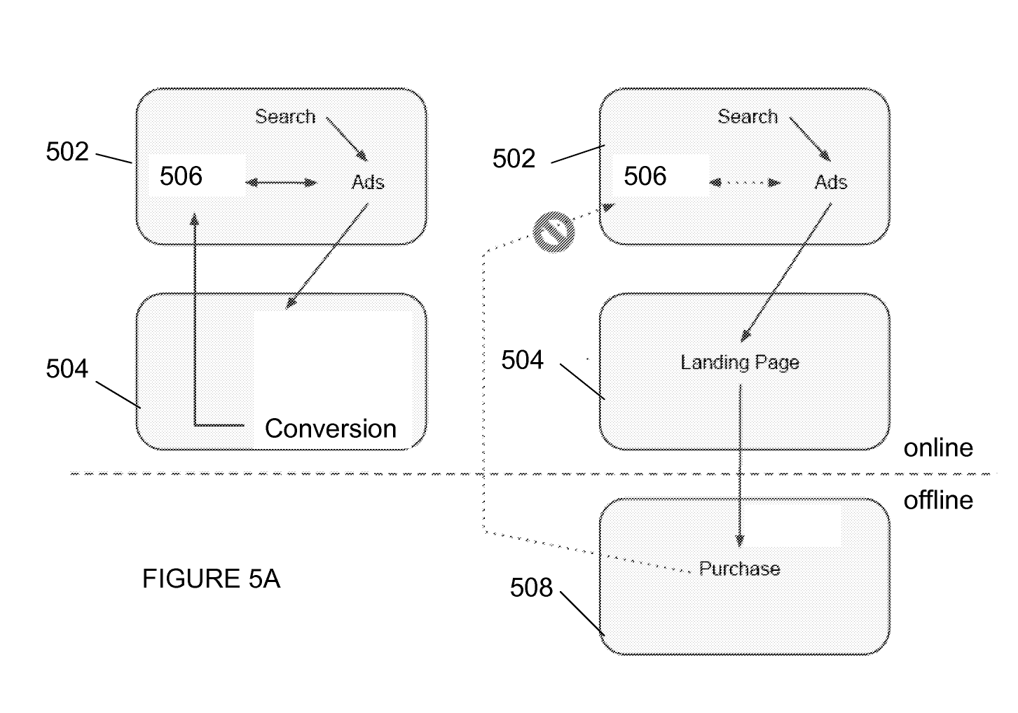

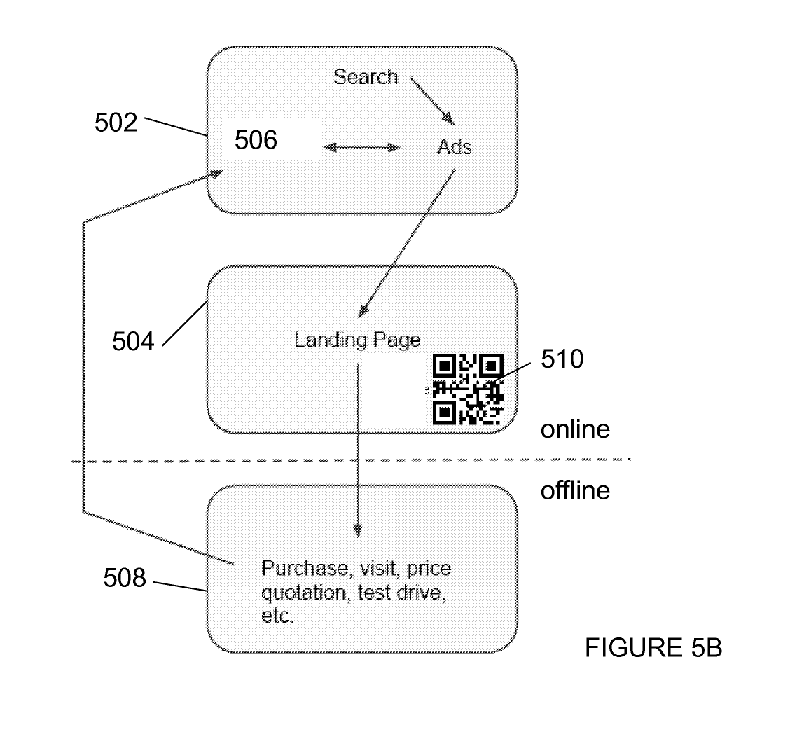

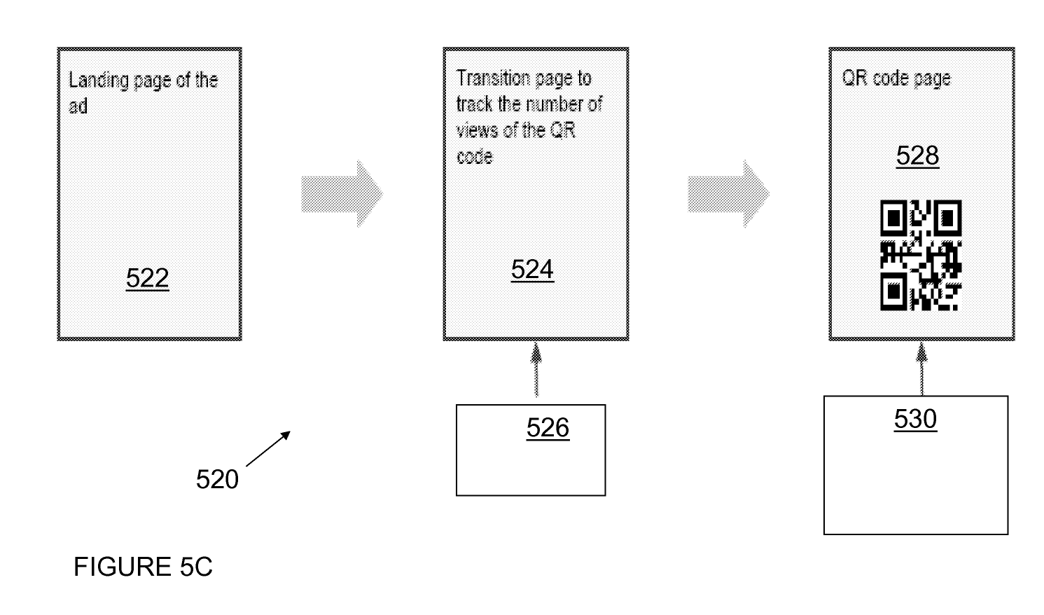

FIG. 5A is a block diagram illustrating logging of online conversions. At block 502, a search engine provider may allow searches to be conducted and ads to be displayed to user identifiers. At block 504, advertisers may allow ads be shown on the landing pages for the user identifiers. The user identifiers can transition from a first landing page to a second landing page, and may conduct be the top page of the advertiser's site. When the user identifier conducts online conversion activities (such as purchases, signing up for memberships, requesting for price quotationsquotes, etc.), the user identifier may be navigated to a second landing page (e.g., “Thank you for your purchase” page). An HTML code snippet may be embedded in the second landing page to log the conversions. At a conversion logging server 506, the conversions can be stored for analysis.

On the other hand, if the user identifiers view the ads online, but visit a physical store 508 at an offline location and have a conversion (e.g., purchase), it may be difficult to link the offline conversions with online activities. However, as illustrated in FIG. 5B, according to some of the described implementations, online activities can be linked through a portable unique ID such as the QR code 510. The QR code 510 may be generated dynamically and can be unique for each user identifier, browser, or the specific online activity. In some implementations, the QR codes enable keyword-level conversion logging for search-related ads, and domain-level logging for contextual ads. By measuring the effects of online ads on revenue at physical stores, ad campaigns can be optimized for conversions.

According to some of the described implementations, advertisers may embed an HTML code for showing the QR code on their landing pages. FIG. 5C shows an example flow 520 for embedding the HTML code and for analyzing the online conversion and offline conversion rates. Here online conversions may be defined as the ratio of user identifiers who viewed the QR code to the total number of user identifiers who visited the landing page 522 of the ad. The offline conversion rate may be defined as the ratio of user identifiers who visited the physical store or purchased a product or a service at the physical store, etc., to the total number of user identifiers who visited the landing page 522. A transition page 524 may be implemented to log the number of views of the QR code. An HTML code 526 can be embedded for the online conversion logging. In a QR code page 528, an HTML code 530 can be embedded for generating and/or displaying the QR code. In some implementations, page 524 and page 528 may be the same page, and HTML code 526 and HTML code 530 may be the same code snippet.

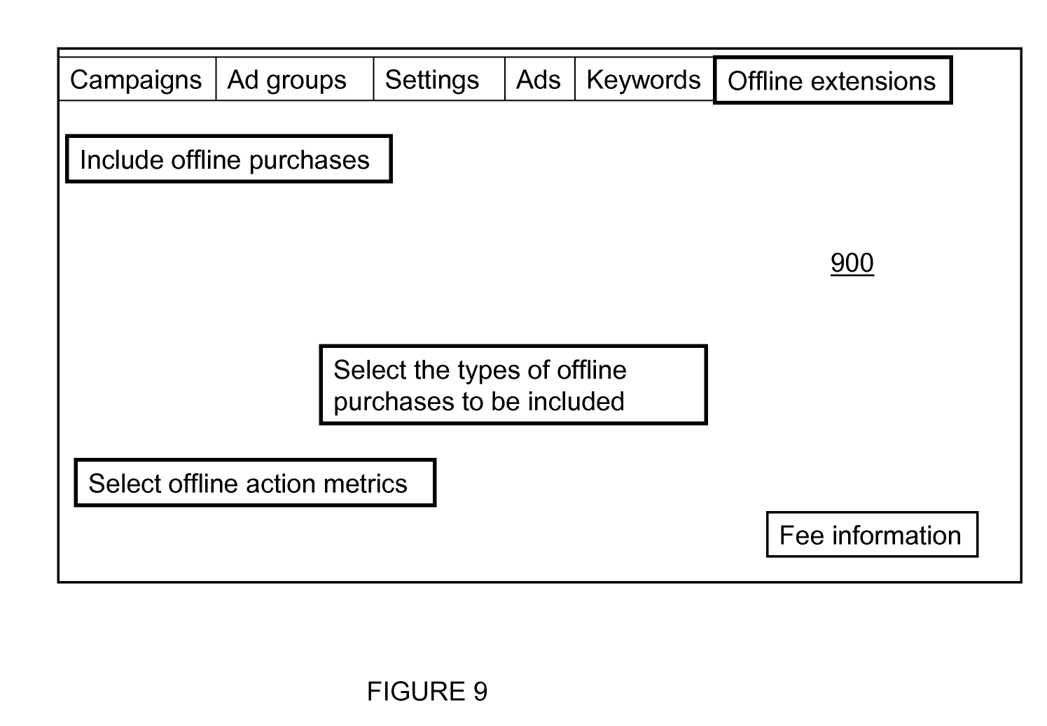

In some implementations, using a web access control platform (see FIG. 9 described below for an example), the content provider (advertiser) can control the advertising efforts including the display of a QR code in the ad. An example HTML code may include a to realize the implementations illustrated in FIGS. 4A and 4B, where the PC to mobile phone transition may not be needed:

<img src=″http://www.service_provider.
com/pagead/conversion/1055674342/?
output=qrcode&ec_level=1&cell_size=2&prefix=http%3A%2F%2Fconversionevent-
generator.appspot.com%2F%3Fcc%3D″ />

The following example URL may be displayed to the advertiser's control panel, and accessed from the device used for the scanning.

http://conversion-event-generator.service_provider.com/setup?
ctid=1055674342&label=RAbbCKKbnwIQ5p-x9wM

During the scanning, an ID for logging the conversion (e.g., conversion_logging_id) and a label for the conversion (e.g., conversion_label) can be stored (e.g., as a cookie) to the device used for scanning Alternatively, the above URL can be accessed from a PC, and the QR code can be scanned by the device, and the encoded URL can be clicked on. An QR code (which may be different from the QR code accessed from the user identifier device, such as that printed on a piece of paper 424, or that illustrated in block 454 of FIG. 4B) can be scanned from a printed piece of paper, or from a display of the mobile phone. This operation may be repeated as many times as needed. The encoded URL may be clicked on, and a verification of a successful QR code generation/display may be shown. After all the QR codes are accessed, the following example URL may be accessed from the device to reset the process: http://conversion-event-generator.service_provider.com/reset. For example, the conversion_logging_id and the conversion_label can be removed in this operation.

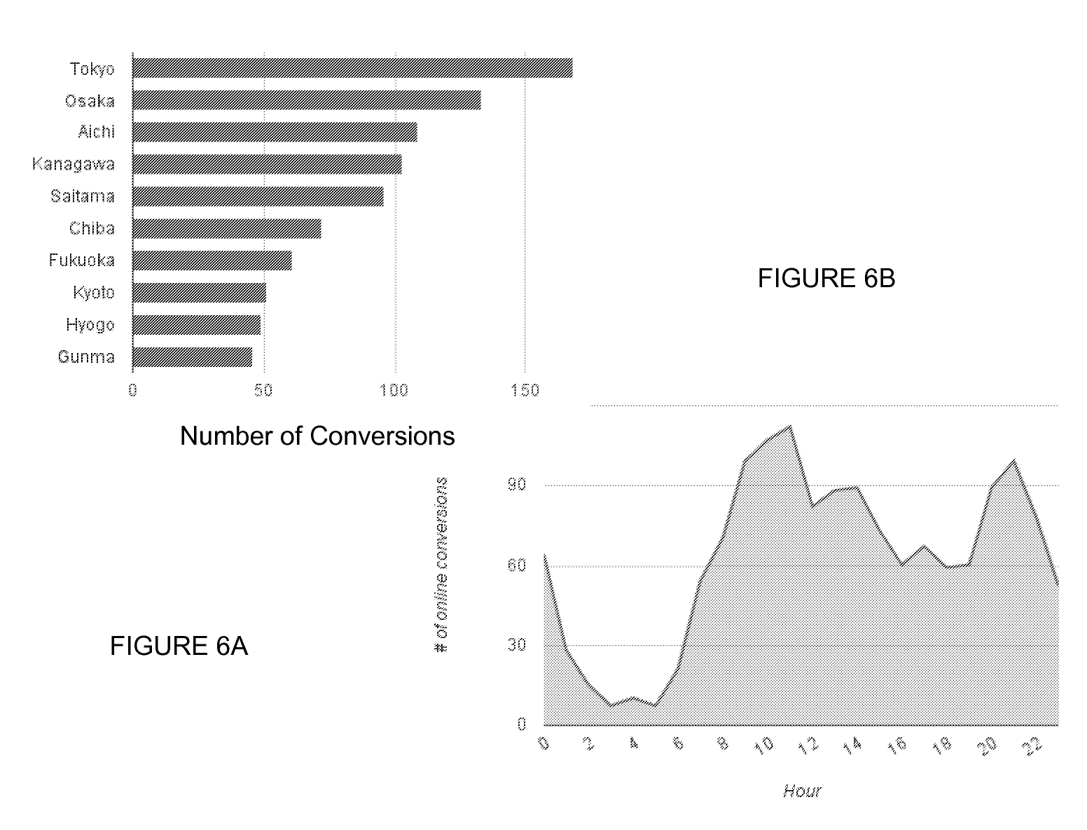

FIGS. 6A and 6B are example reports that may be generated from the logged conversions. For example, FIG. 6A illustrates the number of conversions for different geographical locations, and FIG. 6B illustrates the number of conversions as a function of the time of the day.

Conventional coupon-based online advertisements may use static QR codes or barcodes as coupons, which are taken from a certain fixed set of information and are very static in nature. In contrast, in the described implementations, the QR codes may be unique to each ad click and can be very dynamic in nature, making it possible to conduct very detailed analysis of return on investment, and provide answers to questions such as “which keyword gives the best offline conversion rate?”

The described implementations may also be more advantageous than click-to-call advertisements, the latter having a limited accuracy of conversion rate analysis bounded by the number of phone numbers the advertiser can provide for the campaign, and being limited to phone-call conversions.

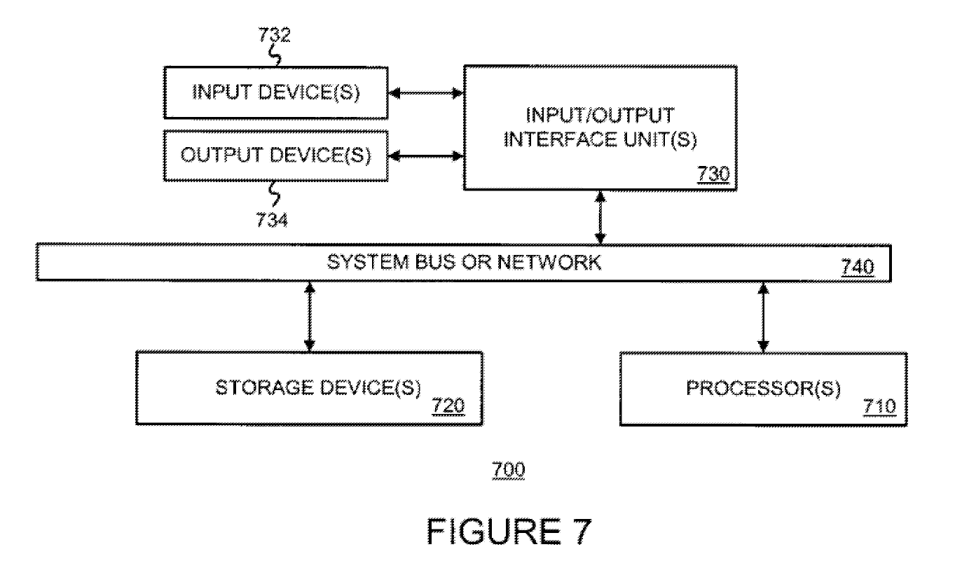

FIG. 7 is a high-level block diagram of a computer-based system 700 that may perform one or more of the operations discussed above. The system 700 may include a server having at least one processing circuit or processor 710, an input/output interface unit 730, a storage device 720, and a system bus or network 740 for facilitating the communication of information among the coupled elements. An input device 732 and an output device 734 may be coupled with the input/output interface 730.

The processor 710 may execute machine-executable instructions stored on, for example, a tangible computer-readable medium, or a non-transitory computer-readable medium to perform one or more aspects of the present disclosure. At least a portion of the machine executable instructions may be stored (temporarily or more permanently) on the storage device 720 and/or may be received from an external source via an input interface unit 730.

The processing unit 710 may be one or more microprocessors. The bus 740 may include a system bus. The storage device 720 may include system memory, such a read only memory (ROM) and/or random access memory (RAM). The storage device 720 can include any suitable type of storage including, for example, a hard disk drive for reading from and writing to a hard disk, a magnetic disk drive for reading from or writing to a (e.g., removable) magnetic disk, an optical disk drive for reading from or writing to a removable (magneto-) optical disk such as a compact disk or other (magneto-) optical media, or any other type of storage medium.

In one implementation, the system 700 may be connected to or include one or more conventional user devices, such as a personal computer, a mobile device, a smart phone, a personal digital assistant (PDA), a tablet computer, a camera, or any other devices that can connect to the system 700 or to the Internet.

A user identifier may enter commands and information into the user device through input device 732, such as a keyboard and pointing device (e.g., a mouse) for example. Other input devices such as a microphone, a touch input interface, a joystick, a game pad, a satellite dish, a scanner, or the like, may also (or alternatively) be included. These and other input devices can be connected to the processor 710 through an appropriate interface 730 coupled to the system bus 740.

The output device 734 may include a monitor or other type of display device, which can be connected to the system bus 740 via an appropriate interface. In addition (or instead of) the monitor, the personal computer may include other (peripheral) output devices (not shown), such as speakers and printers for example. In some cases, output device 734 can include a component for providing one or more of a visual output, a haptic output, or an audio output.

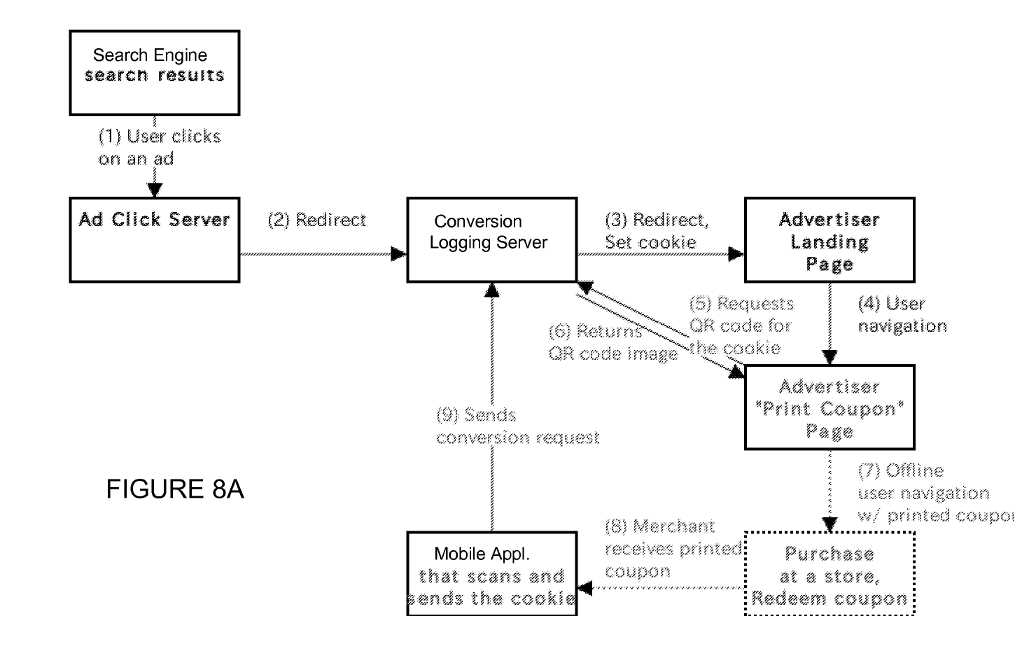

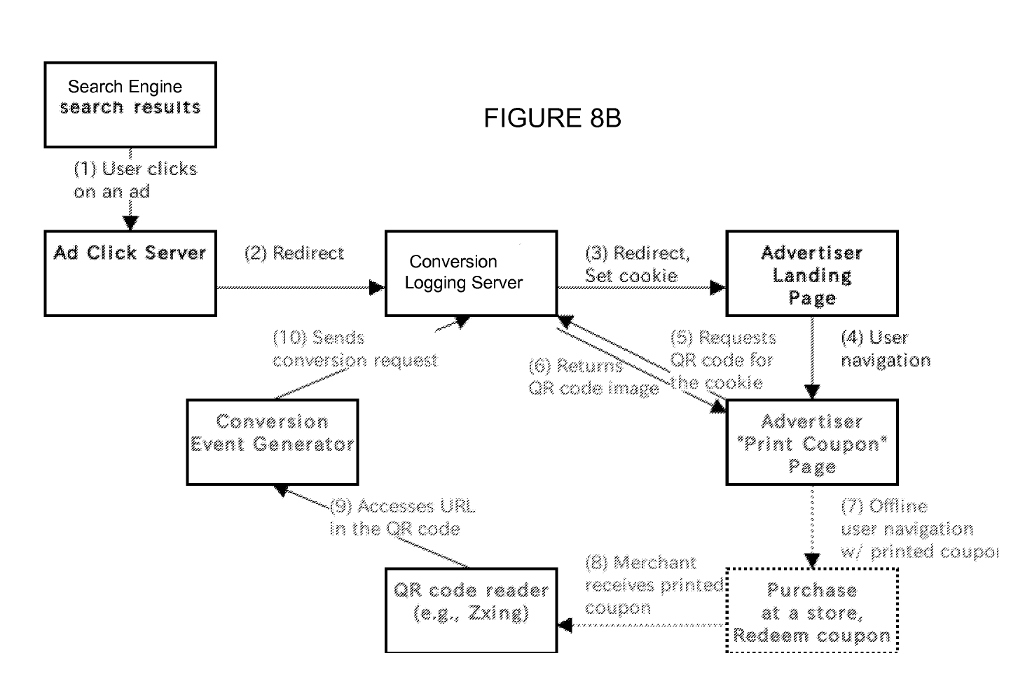

FIG. 8A is a simplified block diagram illustrating an implementation where a mobile application engine may be employed for logging the offline conversions. For example, when a user identifier clicks on an ad such as that displayed together with search results provided by a search engine, the user identifier's browser may send a request to an ad click server with an ad click string and a URL. The request may be directed to a service provider. The service provider may set a conversion cookie for the user identifier, such as with the path attribute /pagead/conversion/<conversion_logging_id>/ and redirects to the advertiser's landing page. The conversion cookie may be stored in the browser cache, and can be appended to the HTTP request header when the requested URL contains www.service_provider.com/pagead/conversion/<conversion_logging_id>/. The interested user identifier may navigate to a “Print Coupon” page, which can be the same as the landing page.

The “Print Coupon” page may contain an HTML snippet such as <img src=“http://www.service_provider.com/pagead/conversion/<conversion_logging_id>/?output=qr code”>. The conversion cookie that was set in the above steps may be added to the HTTP request header. The service provider can look into the cookie field of the HTTP request header (which contains the conversion cookie), build a QR code out of it, and send back a portable network graphics (PNG) file. The user can print out the coupon with the QR code on it and bring it to the store for redemption.

The merchant can use a mobile application that scans and extracts the conversion cookie from the QR code, builds an HTTP request with the cookie, and sends it to www.service_provider.com/pagead/conversion<_conversion_logging_id>/?label=<conversion_label>, at which point a conversion may be considered to have taken place. The conversion label can be set by the merchant (e.g., store ID).

In another implementation as illustrated in FIG. 8B, the merchant does not need a special mobile application to receive the unique ID from the user identifier. In this implementation, instead of a QR code that contains the conversion cookie, the service provider sends a QR code for a URL of a conversion event generator, e.g., http://conversion-eventgenerator.service_provider.com/?cc=<conversion_cookie>. The user identifier can print out the coupon with the QR code, and bring it to the store for redemption. The merchant can use a general QR code reader to extract the URL out of the QR code.

It can be assumed that the merchant has accessed http://conversion-eventgenerator.service_provider.com/setup?ctid=<conversion_logging_id>&label=<conversion_label> to have its cookie set as “ctid=<conversion_logging_id>; label=<conversion_label>” for the domain conversion-event-generator.service_provider.com. The merchant can access the URL http://conversion-event-generator.service_provider.com/?cc=<conversion_cookie> with the cookie<conversion_logging_id> and <conversion_label>. The conversion event generator can build an HTTP request, such as:

GET /pagead/conversion/<conversion_logging_id>/?label=<conversion_label>
Host: www.service_provider.com
Cookie: Conversion=<conversion_cookie>,
to record a conversion.

A conversion may need an access to the service provider at /pagead/conversion/<conversion_logging_id>/?label=<conversion_label> with a valid conversion cookie. Since it may not be desirable to have user identifiers generate conversion events by themselves solely by viewing the QR code, the conversion cookie can be encoded in the QR code, where conversion_logging_id and label can be supplied by the merchant. A knowledgeable user identifier can still look at the HTML snippet for the QR code in the advertiser's landing page to find out the conversion logging ID but not the conversion label. However, there may not be incentives for a user identifier to generate a conversion event on its own.

According to some of the described implementations, a time scale can be selected to associate online activities with offline conversions. In one example, like normal (online) conversions, a time scale of 30 days (from the user identifier's click on the ad) may be selected for offline conversions to be considered valid for association with the ad clicks.

In some implementations, conversion_logging_id may be unique to each merchant's advertising account, and the differentiation between offline conversion types (e.g., store visits, or purchases) can be realized using the conversion_label.

In some implementations, if a user identifier reaches a page with the QR code HTML snippet without clicking on an ad, the QR code would not be shown. Instead, for example, a 1×1 transparent pixel may be shown. As such, the QR code may be generated only if the at least one online activity includes a click on an advertisement.

In some implementations, the data linking online and offline actions can be used by parties other than the advertisers. These parties may include, for example, analytics providers. The data may use the data to conduct research on, for example, industry trends, and user identifier behaviors. The data, with user identifiers' consent, can be licensed to these parties.

FIG. 9 is an abstract illustration of an example of a platform, such as a web access page 900, for the content provider (advertiser) to control the advertising efforts. For example, the advertiser may control the ads at the campaign level or advertisement group level, and may select certain keywords associated with the ad. In addition, according to implementations disclosed herein, the advertiser may select “offline extensions” to extend the advertisement performance metric beyond conventional impression-based or click-based campaigns. Through the offline extension to the ad, the advertiser can select what types of offline purchases to be included in the performance metric of the advertisement.

When the online activities such as viewing the ads are linked with offline conversions, such linking can be used, for example, in an integrated reporting that can indicate the effectiveness of the advertisement by including the resulting offline purchases. This can be helpful in improving optimization and budget decisions for advertising in existing analytics providers. Such analytics providers previously can provide web traffic analysis, and now based on the implementations disclosed herein can provide the value-added correlations between the web traffic and offline actions.

The association between offline conversions and online activities, the advertisement slot auction, and the reporting can be implemented in a computer system including at least one processing circuit. The computer-implemented method can include receiving, using at least one processing circuit of a server, data related to online activities of user identifiers such viewing an online content, and data related to the user's online and offline purchases. The online activities may be performed through a network in a connected state. The network can be, for example, the Internet.

The method may include correlating offline conversions of the user identifiers in response to viewing the advertisement with the online activities. The offline conversions may include actions performed in a disconnected state, such as the user identifiers' offline purchases at physical stores. A performance metric of the advertisement may be predicted or determined based on user identifier action data related to the offline actions, and a value of the advertisement can be determined based on the performance metric. Thus, the performance metric and the value of the advertisement can now be functions of the offline actions such as offline purchases.

In some implementations, the advertisers may be allowed to bid per offline purchase, and the offline purchases may be incorporated as part of an advertisement pricing value. For example, a target bid can be set for an advertising slot for the advertisement based on the pricing value of the advertisement. A specified fee can be charged to an account associated with the advertiser for the offline purchases associated with, or resulting from, a user's viewing the ad.

According to one implementation, advertisement rank calculations can take into account the offline actions. The advertisement rank calculations can determine an ad's position and CPC. The advertiser can influence the advertisement position by specifying a bid per offline action.

In some implementations, offline actions and online activities can be combined to obtain an effective cost of impressions, based on which advertisement ranking and bidding. This advantageously can take into account user identifier activities not immediately or directly linked to the webpage viewing. For example, in some cases an offline purchase may happen some time after the user's viewing the page. The advertiser may choose to be charged/billed based on the offline action, such as offline purchases. Combining the online activities with offline actions provide a better performance metric of the advertisement.

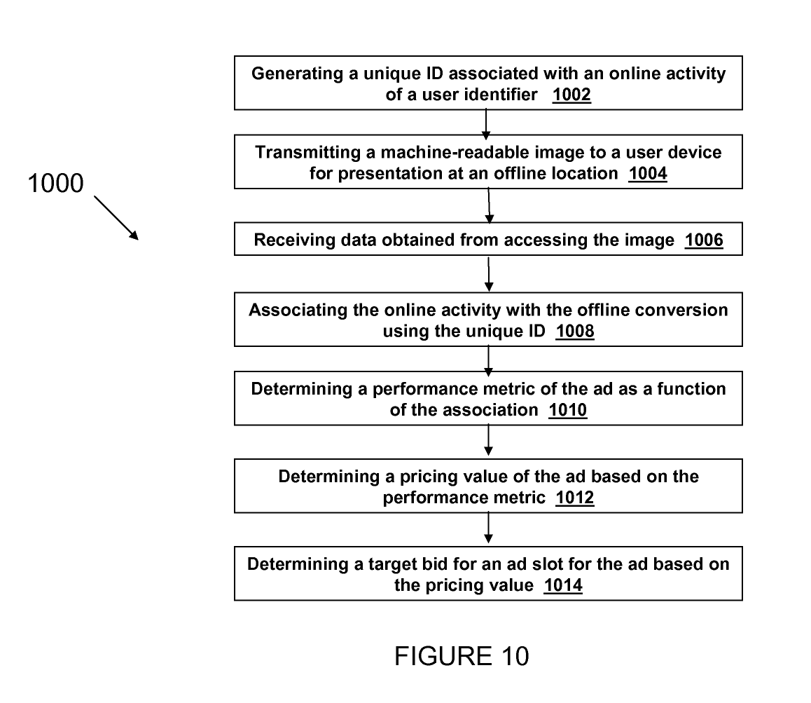

The flowchart of FIG. 10 shows an illustrative method 1000 associated with implementations described above. In an operation 1002, a unique ID can be generated and associated with an online activity, such as a user identifier's click on an ad. The unique ID can be portable through various media, such as a QR code printed on a piece of paper or displayed on a mobile device. Next, in an operation 1004, a machine-readable image can be transmitted to a user device for presentation (e.g., to a merchant) at an offline location (e.g., the physical store) in conjunction with at least one offline action related to the user identifier, wherein the machine-readable image contains information related to the unique ID. The unique ID or information related thereto may be exchanged or transferred between the user identifier and the merchant and the store, such as by scanning the QR code, or wireless transferring the information from the medium or device of the user identifier to a device of the merchant.

Incentives can be provided to the user identifier for opting in to the cookie generation and retrieval, and automatic association with the user identifier. For example, a discount can be automatically applied to an offline purchase after scanning the user identifier's QR code. Alternatively, points can be accumulated to the user identifier's account for future redemption of benefits. In some implementations, collaborations among multiple partners allow sharing of the data on customer interactions with ads/websites/searches, and on purchases. User can opt out of the data collection, while foregoing some convenience of integrated online and offline shopping experience and incentives provided by the advertisers.

In an operation 1006, the server may receive data obtained from accessing the machine-readable image at the offline location. For example, the merchant at the store may scan the QR code from the user's mobile device or from a print out. The scanning may automatically direct the merchant's device to a URL of the server, thereby recording the offline conversion. In an operation 1008, an online activity may be associated with an offline conversion using the unique ID, as the unique ID is associated with both the online activity (during the generation) and the offline action (during the accessing at the offline location).

In an operation 1010, a performance metric for the advertisement may be determined based on activities including the offline conversions. In one example, all the online activities, the online purchase, and the offline purchase are taken into account in determining the performance metric for the ad. The performance metric for the advertisement may be stored and used in the auction process and charging process.

Based on the determined performance metric, online auctions of ads can be performed. For example, in an operation 1012, a pricing value of the ad can be determined based on the performance metric. In an operation 1014, a target bid for an ad slot may be determined for the ad, based on the pricing value. Bids can be received from advertisers together with requests for ads to be displayed on advertisement slots on the webpage to be constructed, for example based on user identifiers' search queries. The bid amount and the predetermined advertisement performance metric can be evaluated together to determine a ranking of the ad. The advertisement of appropriate ranking can be selected and sent for use in constructing the webpage.

While various implementations have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive implementations described herein. More generally, those skilled in the art will readily appreciate that all parameters, dimensions, materials, and configurations described herein are meant to be examples and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive implementations described herein. It is, therefore, to be understood that the foregoing implementations are presented by way of example only and that, within the scope of the appended claims and equivalents thereto, inventive implementations may be practiced otherwise than as specifically described and claimed. Inventive implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described implementations can be implemented in any of numerous ways. For example, some implementations may be implemented using hardware, software or a combination thereof. When any aspect of an implementation is implemented at least in part in software, the software code can be executed on any suitable processor or collection of processors, whether provided in a single device or computer or distributed among multiple devices/computers.

The claims should not be read as limited to the described order or elements unless stated to that effect. It should be understood that various changes in form and detail may be made by one of ordinary skill in the art without departing from the spirit and scope of the appended claims. All implementations that come within the spirit and scope of the following claims and equivalents thereto are claimed.

1. A computer-implemented method of linking online activities with offline actions comprising:
generating, using a processing circuit, a unique ID associated with a specific online activity related to a user identifier;
transmitting a machine-readable image comprising an indication of the unique ID to a first user device, the machine-readable image configured for subsequent presentation at an offline location in conjunction with an offline action related to the user identifier, the offline action performed subsequent to the online activity;
receiving, using the processing circuit, an offline conversion indicator generated by accessing the machine-readable image transmitted to the first user device while presented at the offline location in conjunction with the offline action, the offline conversion indicator associated with the indication of the unique ID;
determining that the machine-readable image has been presented at the offline location in conjunction with the offline action based on the offline conversion indicator generated by accessing the machine-readable image at the offline location;
in response to determining that the machine-readable image has been presented at the offline location in conjunction with the offline action, associating the previous online activity with the subsequent offline action using the unique ID; and
determining, based on associating the previous online activity with the subsequent offline action using the unique ID, that the offline action is performed as a result of the specific online activity associated with the unique ID.

2. The computer-implemented method of claim 1, wherein the online activity comprises at least one of:
a viewing of an advertisement;
an interaction with the advertisement;
a visit to an advertiser's website related to the advertisement; or
a visit to a review website related to the advertisement, and wherein the offline action comprises at least one of:
a visit to a physical store at the offline location,
a purchase of an advertised item product or service at the offline location; or
using the advertised item.

3. The computer-implemented method of claim 2, further comprising:
determining a performance metric of the advertisement as a function of the association between the offline action and the online activity;
determining a pricing value of the advertisement based on the performance metric; and
determining a target bid for an advertising slot for the advertisement based on the pricing value of the advertisement.

4. The computer-implemented method of claim 3, wherein the machine-readable image comprises at least one of a QR code or a barcode specific to the online activity.

5. The computer-implemented method of claim 4, further comprising auctioning the advertising slot based on a bid received from an advertiser and the pricing value of the advertisement.

6. The computer-implemented method of claim 5, further comprising charging an account associated with the advertiser for the offline action.

7. The computer-implemented method of claim 2, further comprising determining a ranking of the advertisement based on an effective cost of impressions that is a function of the offline action.

8. The computer-implemented method of claim 2, wherein the machine-readable image is transmitted to and automatically displayed on the first user device, the method further comprising:
transferring the machine-readable image to a second user device or medium for access at the offline location.

9. The computer-implemented method of claim 8, wherein the machine-readable image comprises at least one of a QR code or a barcode, and wherein the transferring comprises scanning the QR code or barcode on the first user device using the second user device or printing the QR code on a piece of paper, the method further comprising:
scanning the QR code or the barcode from the second user device or from the piece of paper at the offline location.

10. The computer-implemented method of claim 1, wherein the unique ID comprises a cookie stored on a user device.

11. The computer-implemented method of claim 1, wherein the unique ID comprises a link to a page configured to generate a QR code specific to the online activity.

12. The computer-implemented method of claim 11, further comprising:
generating the QR code only if the online activity includes a click on an advertisement.

13. A system for linking online activities with offline actions, the system comprising:
a processing circuit connected to a network, the processing circuit configured to:
generate a unique ID associated with a specific online activity related to a user identifier;
transmit a machine-readable image comprising an indication of the unique ID to a user device, the machine-readable image configured for subsequent presentation at an offline location in conjunction with an offline action related to the user identifier, the offline action performed subsequent to the online activity;
receive an offline conversion indicator generated by accessing the machine-readable image transmitted to the first user device while presented at the offline location in conjunction with the offline action, the offline conversion indicator associated with the indication of the unique ID;
determine that the machine-readable image has been presented at the offline location in conjunction with the offline action based on the offline conversion indicator generated by accessing the machine-readable image at the offline location;
in response to determining that the machine-readable image has been presented at the offline location in conjunction with the offline action, associate the previous online activity with the subsequent offline action using the unique ID; and
determine, based on associating the previous online activity with the subsequent offline action using the unique ID, that the offline action is performed as a result of the specific online activity associated with the unique ID.

14. The system of claim 13,
wherein the online activity comprises at least one of:
a viewing of an advertisement;
an interaction with the advertisement;
a visit to an advertiser's website related to the advertisement; or
a visit to a review website related to the advertisement, and
wherein the offline action comprises at least one of:
a visit to a physical store at the offline location,
a purchase of an advertised item product or service at the offline location; or
using the advertised item at the offline location.

15. The system of claim 14, wherein the unique ID comprises at least one of a QR code or a barcode specific to the online action.

16. The computer system of claim 14, wherein the unique ID comprises a cookie, and wherein the processing circuit is further configured to:
generating a quick response (QR) code when accessing the cookie.

17. The computer system of claim 14, wherein the unique ID comprises a quick response (QR) code indicating a URL link, and wherein the processing circuit is further configured to:
redirect a request for a web page to an advertiser's landing page having the link.

18. A non-transitory computer readable medium having instructions for linking online activities with offline actions stored thereon, wherein the instructions comprise:
generating a unique ID associated with a specific online activity related to a user identifier;
transmitting a machine-readable image comprising an indication of the unique ID to a user device, the machine-readable image configured for subsequent presentation at an offline location in conjunction with an offline action related to the user identifier, the offline location performed subsequent to the online activity;
receiving an offline conversion indicator generated by accessing the machine-readable image transmitted to the first user device while presented at the offline location in conjunction with the offline action, the offline conversion indicator associated with the indication of the unique ID;
determining that the machine-readable image has been presented at the offline location in conjunction with the offline action based on the offline conversion indicator generated by accessing the machine-readable image at the offline location;
in response to determining that the machine-readable image has been presented at the offline location in conjunction with the offline action, associating the previous online activity with the subsequent offline action using the unique ID; and
determining, based on associating the previous online activity with the subsequent offline action using the unique ID, that the offline action is performed as a result of the specific online activity associated with the unique ID.

19. The non-transitory computer readable medium of claim 18, wherein the unique ID comprises a, and wherein the instructions further comprise:
generating a quick response (QR) code when accessing the cookie.

20. The non-transitory computer readable medium of claim 18, wherein the unique ID comprises a link, and wherein the instructions further comprise:
redirecting a request for a web page to an advertiser's landing page having the link.
